(19) United States
(12) Patent Application Publication
(10) Pub. No.: US 2026/0368572 A1
(43) Pub. Date: Nov. 19, 2026

(54) SYSTEMS AND METHODS FOR AUTOMATED GENERATION, DEPLOYMENT, AND EXECUTION OF DIRECTED ACYCLIC GRAPHS

(71) Applicant: CVS Pharmacy, Inc., Woonsocket, RI (US)

(72) Inventors: Vidit Jain, Woonsocket, RI (US); Chandan Singh Troughia, Woonsocket, RI (US); Muhammed Ali Jowher, Woonsocket, RI (US); Pushkar Vashishtha, Woonsocket, RI (US); Kuntal Ghosh, Woonsocket, RI (US); Moses Sam Paul Vincent Paul, Woonsocket, RI (US)

(21) Appl. No.: 19/209,112

(22) Filed: May 15, 2025

(51) Int. Cl. G06N 7/01; G06F 8/71

(52) U.S. Cl. CPC G06N 7/01; G06F 8/71

(57) ABSTRACT

In some instances, a method is provided. The method comprises: creating a Directed Acyclic Graph (DAG) based on instructions from a user device, wherein the DAG indicates a plurality of tasks and a plurality of indicators indicating a sequential flow for performing the plurality of tasks; based on the created DAG, retrieving a plurality of operators for the plurality of tasks from one or more databases; building run-time execution code for the created DAG based on the plurality of retrieved operators and the sequential flow for performing the plurality of tasks; and pushing the run-time execution code to a continuous integration and continuous deployment (CI/CD) computing platform, wherein the CI/CD computing platform is configured to deploy and execute the run-time execution code for the created DAG.

### BACKGROUND

A directed acyclic graph (DAG) may indicate a collection of tasks to be executed, and the DAG may be organized in a manner that reflects the relationships and dependencies of the tasks. For instance, an example of a DAG may include tasks for downloading data such as videos from a server, storing the downloaded data within a repository, and forwarding the downloaded data within the repository to a user device at a particular time interval (e.g., each morning). As such, the example DAG includes three tasks and each of the tasks is to be performed in a set order for the DAG to be executed properly. For example, without storing the downloaded data within the repository and when the task arises to forward the downloaded data to the user device, there might not be any downloaded data within the repository. Thus, the follow-up task would fail as the user device fails to receive any data.

Traditionally, DAGs may include a plurality of tasks that are interconnected to each other in various approaches. However, even in the example above with just three tasks, the DAG may be difficult to program and/or execute by a layperson. For example, a user that is seeking to obtain the data from the server each morning may have to understand not only the name of the particular server where the desired data is stored as well as which repository to store the data such that the data may be provided to them each morning, but also how to code this information within the DAG to execute the DAG properly. Without having this vital information, it becomes difficult to deploy and implement the DAG for the task. Accordingly, to help facilitate the process, there remains a technical need to automate the generation, deployment, and execution of DAGs to perform one or more tasks.

### SUMMARY

In some examples, the present application provides a method and system for the automated generation, deployment, and execution of DAGs to perform one or more tasks such as a task of downloading and providing the data to a user at periodic time intervals. For instance, a user device may access a portal (e.g., a DAG Automation and Reporting Tool (DART) portal) to facilitate the deployment and implementation of a new DAG. For example, a DAG generation computing platform may be configured to generate and deploy DAGs based on user input from the user device. For example, the portal may include a plurality of fillable fields for the new DAG, including general information for the DAG (e.g., the name of the DAG, the schedule for the DAG, the start date for the DAG), new tasks for the DAG, parameters for the new tasks, and/or other information. The user device may obtain user input associated with the plurality of fillable fields and provide the user input to the DAG generation computing platform.

After receiving the user input, the DAG generation computing platform may retrieve operators (e.g., software code) associated with the new tasks from a database. Subsequently, based on the user input and the retrieved operators, the DAG generation computing platform may generate run-time execution code for the DAG and push the run-time execution code to a continuous integration/continuous delivery (CI/CD) computing platform. The CI/CD computing platform may acknowledge the change in the run-time execution code, deploy the run-time execution code to a run-time environment, and execute the run-time execution code to perform one or more tasks. For example, the CI/CD computing platform may include a version controller and/or a development operations (DevOps) tool to facilitate the functionalities described above. Then, based on executing the run-time execution code, the one or more tasks of the DAG may be performed. For instance, in the example above, the task of downloading data such as videos may be performed and the CI/CD computing platform may provide the downloaded data to the user device 104. The automated generation, deployment, and execution of DAGs to perform the one or more tasks will be described in further detail below.

In one aspect, a computing system is provided. The system comprises a user device configured to: obtain user input comprising new tasks and new task parameters for creation of a new Directed Acyclic Graph (DAG), wherein the user input indicates for the new DAG to download DAG data from one or more external data sources and provide the DAG data back to the user device at a set time interval; and based on the user input, provide instructions to a DAG generation computing platform to direct the DAG generation computing platform to generate and implement the new DAG. The system further comprises the DAG generation computing platform configured to: create the new DAG based on the instructions, wherein the new DAG indicates the new tasks and a plurality of indicators indicating a sequential flow for performing the new tasks; based on the created DAG, retrieve a plurality of operators for the new tasks from one or more databases; build run-time execution code for the created DAG based on the plurality of retrieved operators and the user input; and push the run-time execution code to a continuous integration and continuous deployment (CI/CD) computing platform. The system further comprises: the CI/CD computing platform configured to: deploy the run-time execution code within a run-time environment; and execute the deployed run-time execution code to perform the new tasks, wherein executing the deployed run-time execution code comprises: downloading the DAG data from the one or more external data sources; and providing the DAG data back to the user device at the set time interval.

Examples may include one of the following features, or any combination thereof. For instance, in some examples, obtaining the user input comprises: accessing a DAG automation and reporting tool (DART) portal hosted by the DAG generation computing platform; based on accessing the DART portal, displaying one or more user interfaces on a display of the user device; and obtaining the user input based on the one or more displayed user interfaces.

In some instances, obtaining the user input based on the one or more displayed user interfaces comprises: based on displaying a first user interface of the one or more user interfaces, obtain first user input indicating general information associated with the new DAG; based on displaying a second user interface of the one or more user interfaces, obtain second user input indicating the new tasks for the new DAG, wherein the new tasks comprise a first task; and based on displaying a third user interface of the one or more user interfaces, obtain third user input indicating the new task parameters for the first task for the new DAG.

In some examples, the new tasks comprise a first task associated with a first programming language and a second task associated with a second programming language that is different from the first programming language, and wherein retrieving the plurality of operators for the new tasks comprises: retrieving a first operator from a first database from the one or more databases based on the first programming language associated with the first task; and retrieving a second operator from a second database from the one or more databases based on the second programming language associated with the second task.

In some variations, the DAG generation computing platform is further configured to: obtain the first operator from a second user device, wherein the first operator is a custom operator; and store the first operator within the first database, wherein the first database stores a plurality of custom operators.

In some instances, the CI/CD computing platform is further configured to: obtain the run-time execution code from the DAG generation computing platform; and acknowledge that the run-time execution code associated with the new DAG has not been previously deployed by the CI/CD computing platform, wherein deploying the run-time execution code within the run-time environment is based on the acknowledgement.

In some examples, the CI/CD computing platform comprises a version controller and a development operations (DevOps) tool, wherein the CI/CD computing platform is configured to acknowledge that the run-time execution code is associated with the new DAG using the version controller, and wherein the CI/CD computing platform is configured to deploy the run-time execution code within the run-time environment using the DevOps tool.

In some variations, the system further comprises: a monitoring and alerting computing platform configured to: subsequent to the CI/CD computing platform deploying the run-time execution code, monitor the deployed DAG; and provide, to the user device, data quality results and/or notifications associated with the CI/CD computing platform executing the run-time execution code for the deployed DAG.

In some instances, the system further comprises: a monitoring and alerting computing platform configured to: in response to the DAG generation computing platform pushing the run-time execution code to the CI/CD computing platform, monitor the deployment and execution of the run-time execution code by the CI/CD computing platform; and provide, to the user device, data quality results and/or notifications associated with monitoring the CI/CD computing platform.

In another aspect, a method is provided. The method comprises: creating a Directed Acyclic Graph (DAG) based on instructions from a user device, wherein the DAG indicates a plurality of tasks and a plurality of indicators indicating a sequential flow for performing the plurality of tasks; based on the created DAG, retrieving a plurality of operators for the plurality of tasks from one or more databases; building run-time execution code for the created DAG based on the plurality of retrieved operators and the sequential flow for performing the plurality of tasks; and pushing the run-time execution code to a continuous integration and continuous deployment (CI/CD) computing platform, wherein the CI/CD computing platform is configured to deploy and execute the run-time execution code for the created DAG.

Examples may include one of the following features, or any combination thereof. For instance, in some examples, the plurality of tasks comprise a first task associated with a first programming language and a second task associated with a second programming language that is different from the first programming language, and wherein retrieving the plurality of operators for the plurality of tasks comprises: retrieving a first operator from a first database from the one or more databases based on the first programming language associated with the first task; and retrieving a second operator from a second database from the one or more databases based on the second programming language associated with the second task.

In some instances, the method further comprises: obtaining the first operator from a second user device, wherein the first operator is a custom operator; and storing the first operator within the first database, wherein the first database stores a plurality of custom operators.

In some examples, the method further comprises: obtaining additional instructions from the user device indicating one or more updates to the created DAG; and updating the run-time execution code for the created DAG based on the one or more updates.

In some variations, the method further comprises: providing the created DAG to the user device for review, wherein obtaining the additional instructions from the user device is in response to providing the created DAG to the user device for review, and wherein pushing the run-time execution code to the CI/CD computing platform comprises pushing the updated run-time execution code for the created DAG to the CI/CD computing platform.

In some instances, obtaining the additional instructions from the user device indicating the one or more updates to the created DAG is subsequent to the CI/CD computing platform deploying and executing the run-time execution code for the created DAG, and wherein the method further comprises: pushing the updated run-time execution code to the CI/CD computing platform; using, by the CI/CD computing platform, a version controller to compare the updated run-time execution code with the run-time execution code that is currently being executed; acknowledging, by the CI/CD computing platform, changes within the updated run-time execution code based on the comparison; and deploying, by the CI/CD computing platform, the updated run-time execution code based on the acknowledgement.

In some examples, the CI/CD computing platform comprises the version controller and a development operations (DevOps) tool, wherein deploying the updated run-time execution code comprises deploying, using the DevOps tool, the run-time execution code within the run-time environment.

In some variations, the method further comprises: obtaining, by the CI/CD computing platform, the run-time execution code from a DAG generation computing platform; acknowledging, by the CI/CD computing platform, that the run-time execution code associated with the DAG has not been previously deployed by the CI/CD computing platform; and deploying, by the CI/CD computing platform, the run-time execution code within a run-time environment based on the acknowledgement.

In some instances, the method further comprises: subsequent to the CI/CD computing platform deploying the run-time execution code, monitoring, by a monitoring and alerting computing platform, the DAG; and providing, by the monitoring and alerting computing platform and to the user device, data quality results and/or notifications associated with the CI/CD computing platform executing the run-time execution code for the DAG.

In some examples, the method further comprises: in response to pushing the run-time execution code to the CI/CD computing platform, monitoring, by a monitoring and alerting computing platform, the deployment and execution of the run-time execution code by the CI/CD computing platform; and providing, by the monitoring and alerting computing platform and to the user device, data quality results and/or notifications associated with monitoring the CI/CD computing platform.

In yet another aspect, a non-transitory computer-readable medium having processor-executable instructions stored thereon is provided. The processor-executable instructions, when executed, facilitate: creating a Directed Acyclic Graph (DAG) based on instructions from a user device, wherein the DAG indicates a plurality of tasks and a plurality of indicators indicating a sequential flow for performing the plurality of tasks; based on the created DAG, retrieving a plurality of operators for the plurality of tasks from one or more databases; building run-time execution code for the created DAG based on the plurality of retrieved operators and the sequential flow for performing the plurality of tasks; and pushing the run-time execution code to a continuous integration and continuous deployment (CI/CD) computing platform, wherein the CI/CD computing platform is configured to deploy and execute the run-time execution code for the created DAG.

All examples and features mentioned herein may be combined in any technically possible way.

### BRIEF DESCRIPTION OF THE DRAWINGS

The subject technology will be described in even greater detail below based on the exemplary figures, but is not limited to the examples. All features described and/or illustrated herein can be used alone or combined in different combinations. The features and advantages of various examples will become apparent by reading the following detailed description with reference to the attached drawings which illustrate the following:

FIG. 1 is a simplified block diagram depicting an exemplary computing environment in accordance with one or more examples of the present application.

FIG. 2 is a simplified block diagram of one or more devices or systems within the exemplary environment of FIG. 1.

FIG. 3 is an exemplary process for the automated generation, deployment, and execution of DAGs in accordance with one or more examples of the present application.

FIGS. 4A-4D show an exemplary event sequence for the automated generation, deployment, and execution of DAGs in accordance with one or more examples of the present application.

FIGS. 5A-5D show exemplary user interfaces that are used to create and/or update a DAG in accordance with one or more examples of the present application.

FIG. 6 shows an exemplary DAG in accordance with one or more examples of the present application.

FIG. 7 shows exemplary run-time execution code for the DAG in accordance with one or more examples of the present application.

### DETAILED DESCRIPTION

Examples of the presented application will now be described more fully hereinafter with reference to the accompanying FIGS., in which some, but not all, examples of the application are shown. Indeed, the application may be exemplified in different forms and should not be construed as limited to the examples set forth herein; rather, these examples are provided so that the application will satisfy applicable legal requirements. Where possible, any terms expressed in the singular form herein are meant to also include the plural form and vice versa, unless explicitly stated otherwise. Also, as used herein, the term “a” and/or “an” shall mean “one or more” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on”.

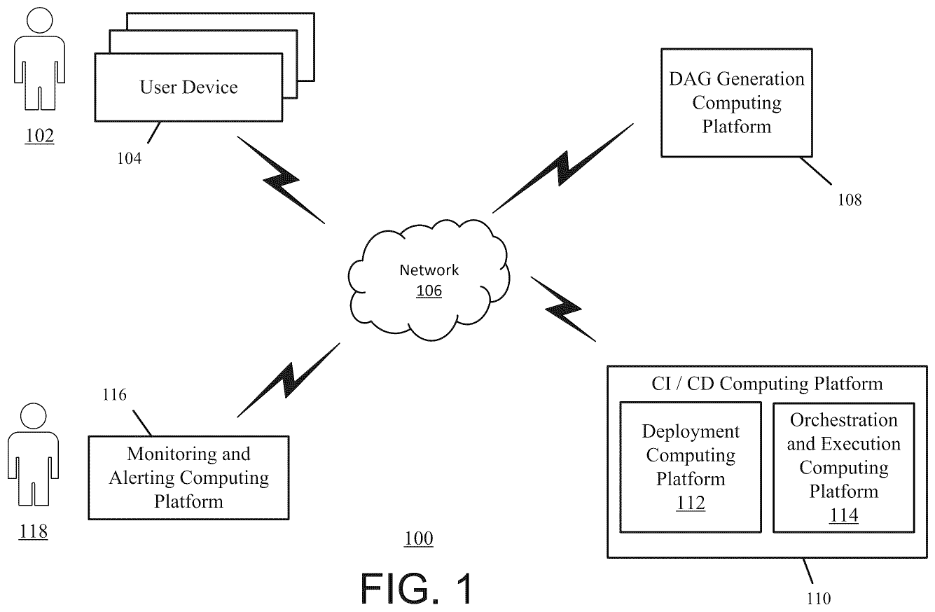

Systems, methods, and computer program products are herein disclosed that facilitate automated generation, deployment, and execution of DAGs. FIG. 1 is a simplified block diagram depicting an exemplary environment 100 in accordance with an example of the present application. For instance, FIG. 1 describes a groundbreaking computing environment through a streamlined block diagram that may revolutionize processing and managing data in real-time. The environment 100 includes users 102, user devices 104, a network 106, a DAG generation computing platform 108, a CI/CD computing platform 110, and a monitoring and alerting computing platform 116. The CI/CD computing platform 110 includes a deployment computing platform 112 and an orchestration and execution computing platform 114. Although the entities within environment 100 may be described below and/or depicted in the FIGS. as being singular entities, it will be appreciated that the entities and functionalities discussed herein may be implemented by and/or include one or more entities. For instance, the DAG generation computing platform 108 and/or the CI/CD computing platform 110 may include a plurality of computing devices, systems, platforms, repositories, and/or servers that are spread across multiple different geographical locations and communicate with each other using direct connections and/or the network 106.

The entities within the environment 100 such as the user devices 104, the DAG generation computing platform 108, the CI/CD computing platform 110, and the monitoring and alerting computing platform 116 may be in communication with other devices and/or systems within the environment 100 via the network 106. The network 106 may be a global area network (GAN) such as the Internet, a wide area network (WAN), a local area network (LAN), or any other type of network or combination of networks. The network 106 may provide a wireline, wireless, or a combination of wireline and wireless communication between the entities within the environment 100

The users 102 may own, operate, and/or otherwise be associated with the user devices 104. For example, a first user 102 may use a first user device 104 such as a laptop or personal/work computer to perform one or more responsibilities for an enterprise organization. For instance, the first user 102 may require certain data each day in order to perform the responsibilities, but might not have the coding experience necessary to automate the retrieval of such data each day. Accordingly, users 102, including the first user 102, may use the user devices 104 to generate, deploy, and execute DAGs to perform one or more tasks for the enterprise organization.

The user devices 104 are and/or include, but are not limited to, a desktop, laptop, tablet, mobile device (e.g., smartphone device, or other mobile device), smart watch, an internet of things (IOT) device, or any other type of computing device that generally comprises one or more communication components, one or more processing components, and one or more memory components. The user devices 104 may be able to execute software applications and/or programs. Additionally, and/or alternatively, the user devices 104 may be configured to operate a web browser to connect to a web page and/or applications.

To generate the DAG, the user device 104 may provide user input to the DAG generation computing platform 108. The DAG generation computing platform 108 may be configured to generate the DAGs, which may be provided back to the user device 104 for review by the user 102. Additionally, and/or alternatively, the DAG generation computing platform 108 may be configured to generate (e.g., build) run-time execution code associated with the DAGs and push the run-time execution code to the CI/CD computing platform 110. For example, based on the user input indicating the tasks and/or task parameters for the DAG, the DAG generation computing platform 108 may retrieve operators (e.g., software code associated with the task) from one or more databases, repositories, and/or other types of storage mediums. For instance, the DAG generation computing platform 108 may include and/or be associated with databases, repositories, and/or other types of storage mediums that store a plurality of operators. Based on the user input indicating a task such as download data from a particular server or store the downloaded data into a particular server, the DAG generation computing platform 108 may retrieve operators associated with the user input and/or the tasks. Subsequently, the DAG generation computing platform 108 may generate the DAG and/or build run-time execution code based on the retrieved operators. Following, the DAG generation computing platform 108 may push the run-time execution code to the CI/CD computing platform 110.

The DAG generation computing platform 108 may be and/or include, but is not limited to, a desktop, laptop, tablet, mobile device (e.g., smartphone device, or other mobile device), an internet of things (IOT) device, server, repository, database, and/or any other type of computing system that generally comprises one or more communication components, one or more processing components, and one or more memory components. The DAG generation computing platform 108 may be able to perform functionalities for an enterprise organization and/or other institutions. The enterprise organization may be any type of corporation, company, organization, and/or other institution that provides one or more goods and/or services.

The CI/CD computing platform 110 may be configured to obtain the run-time execution code from the DAG generation computing platform 108. As mentioned above, the CI/CD computing platform 110 may include a deployment computing platform 112 and an orchestration and execution computing platform 114. For instance, the deployment computing platform 112 (e.g., a version controller and/or a DevOps tool) may be configured to acknowledge changes in the run-time execution code. Subsequently, the orchestration and execution computing platform 114 may be configured to deploy run-time execution code to a run-time environment and execute the run-time execution code to perform one or more tasks. For instance, the orchestration and execution computing platform 114 may be a run-time execution platform such as APACHE AIRFLOW that may operate locally on any cloud network and/or platform.

In other words, in some examples, the CI/CD computing platform 110 may receive runtime execution code from the DAG generation computing platform 108. The CI/CD computing platform 110 may include a deployment computing platform 112 and an orchestration and execution computing platform 114, which may work together to manage and/or execute the runtime code. The deployment computing platform 112, acting as a version control and automation system, may detect changes in the runtime execution code. Upon detecting a change, the deployment computing platform 112 may initiate a deployment pipeline, triggering the orchestration and execution computing platform 114. The orchestration and execution computing platform 114, serving as a runtime environment and workflow manager, may then deploy the runtime execution code to the appropriate execution environment and may orchestrate its execution to perform the defined tasks.

For instance, in the example above, the user input may indicate for the DAG to download data (e.g., videos), store them in a repository, and forward them back to the user device 104 every morning. As such, based on the run-time execution code that is generated by the DAG generation computing platform 108, the CI/CD computing platform 110 may be configured to deploy and execute the run-time execution code. For example, the CI/CD computing platform 110 may be configured to download the data and store them in a repository (e.g., a repository associated with the CI/CD computing platform 110). Then, at the appropriate time indicated by the user input (e.g., every morning), the CI/CD computing platform 110 may provide the data from the repository back to the user device 104.

The CI/CD computing platform 110 may be and/or include, but is not limited to, a desktop, laptop, tablet, mobile device (e.g., smartphone device, or other mobile device), an internet of things (IOT) device, server, repository, database, and/or any other type of computing system that generally comprises one or more communication components, one or more processing components, and one or more memory components.

In addition to the above, the environment 100 may further include the monitoring and alerting computing platform 116. The monitoring and alerting computing platform 116 may be configured to monitor the deployed DAGs and/or deployed run-time execution codes within the CI/CD computing platform 110. In addition, based on the monitoring, the monitoring and alerting computing platform 116 may determine failures associated with the deployed DAGs and/or run-time execution codes. For example, taking the example above, the user device 104 might not receive any of the requested data. The monitoring and alerting computing platform 116 may determine not only that the deployed DAG/run-time execution code failed, but also which task failed within the deployed DAG. For example, the monitoring and alerting computing platform 116 may determine that the data was downloaded properly from the appropriate server but was not saved within the repository. In other words, the second task from the DAG may have failed. Thus, the monitoring and alerting computing platform 116 may provide data quality results, alerts, and/or notifications to the user device 104 indicating that the DAG failed and also which task within the DAG failed. Additionally, and/or alternatively, the monitoring and alerting computing platform 116 may provide, to the user device 104, notifications and/or alerts indicating the quality of the data and/or the artifact quality to the user 102. The artifact quality may indicate a quality of a report, table, and/or other data structures associated with the DAG.

The monitoring and alerting computing platform 116 may be and/or include, but is not limited to, a desktop, laptop, tablet, mobile device (e.g., smartphone device, or other mobile device), an internet of things (IOT) device, server, repository, database, and/or any other type of computing system that generally comprises one or more communication components, one or more processing components, and one or more memory components.

It will be appreciated that the exemplary environment 100 depicted in FIG. 1 is merely an example, and that the principles discussed herein may also be applicable to other situations—for example, including other types of institutions, organizations, devices, systems, and network configurations. For example, in some variations, the functionalities of the DAG generation computing platform 108 and/or the CI/CD computing platform 110 may be separated into multiple different entities that communicate with each other using the network 106.

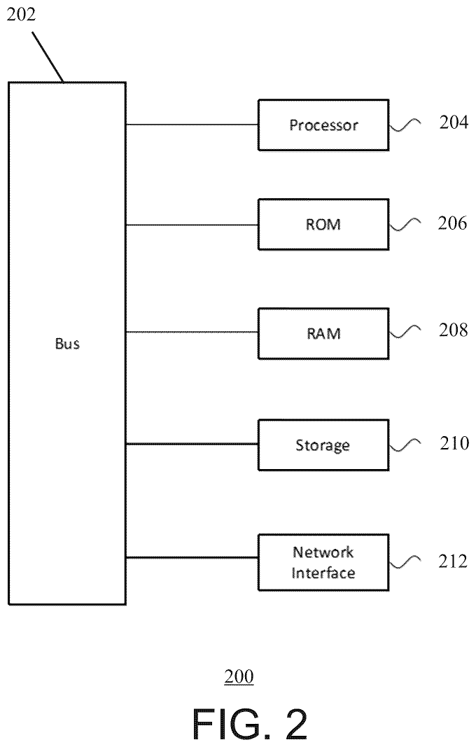

FIG. 2 is a block diagram of an exemplary system and/or device 200 within the environment 100. For instance, FIG. 2 may show an innovative system architecture, featuring state-of-the-art components that seamlessly integrate within the transformative environment introduced in FIG. 1. The device/system 200 includes one or more processors 204, such as one or more CPUs, controller, and/or logic, that executes computer executable instructions for performing the functions, processes, and/or methods described herein. In some examples, the computer executable instructions are locally stored and accessed from a non-transitory computer readable medium, such as storage 210, which may be a hard drive or flash drive. Read Only Memory (ROM) 206 includes computer executable instructions for initializing the processor 204, while the random-access memory (RAM) 208 is the main memory for loading and processing instructions executed by the processor 204. The network interface 212 may connect to a wired network or cellular network and to a local area network or wide area network, such as the network 106. The device/system 200 may also include a bus 202 that connects the processor 204, ROM 206, RAM 208, storage 210, and/or the network interface 212. The components within the device/system 200 may use the bus 202 to communicate with each other. The components within the device/system 200 are merely exemplary and might not be inclusive of every component, server, device, computing platform, and/or computing apparatus within the device/system 200. Additionally, and/or alternatively, the device/system 200 may further include components that might not be included within every entity of environment 100.

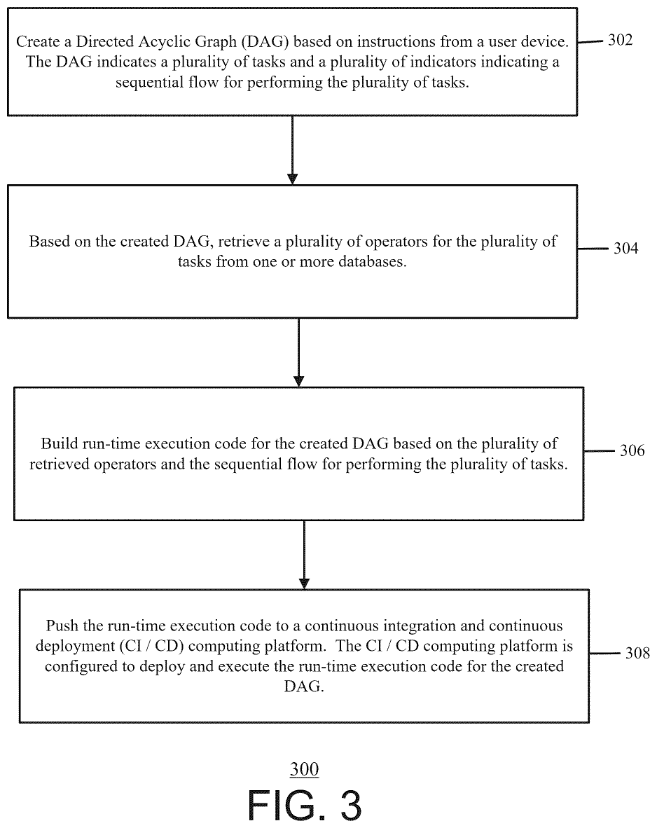

FIG. 3 is an exemplary process 300 for the automated generation, deployment, and execution of DAGs in accordance with one or more examples of the present application. For example, FIG. 3 shows an automated workflow system, which may deliver unprecedented efficiency in DAG generation, deployment, and execution. In some examples, the process 300 may reduce manual intervention by over 80%. The process 300 may be performed by one or more entities of environment 100 shown in FIG. 1 such as the DAG generation computing platform 108 and/or the CI/CD computing platform 110. It will be recognized that any of the following blocks may be performed in any suitable order, and that the process 300 may be performed in any suitable environment. The descriptions, illustrations, and processes of FIG. 3 are merely exemplary and the process 300 may use other descriptions, illustrations, and processes for maintaining and updating provider databases and providing recommended providers to users.

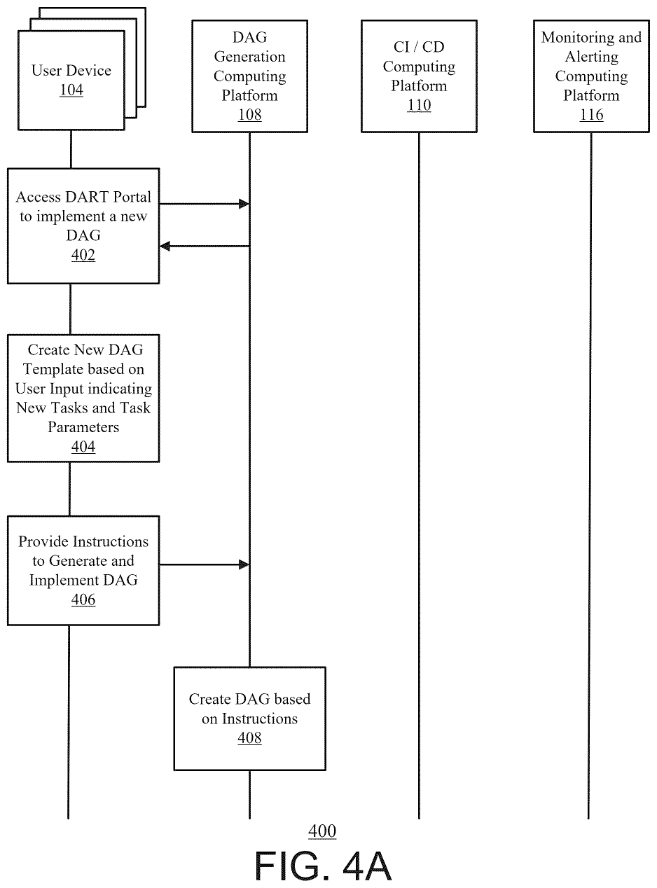

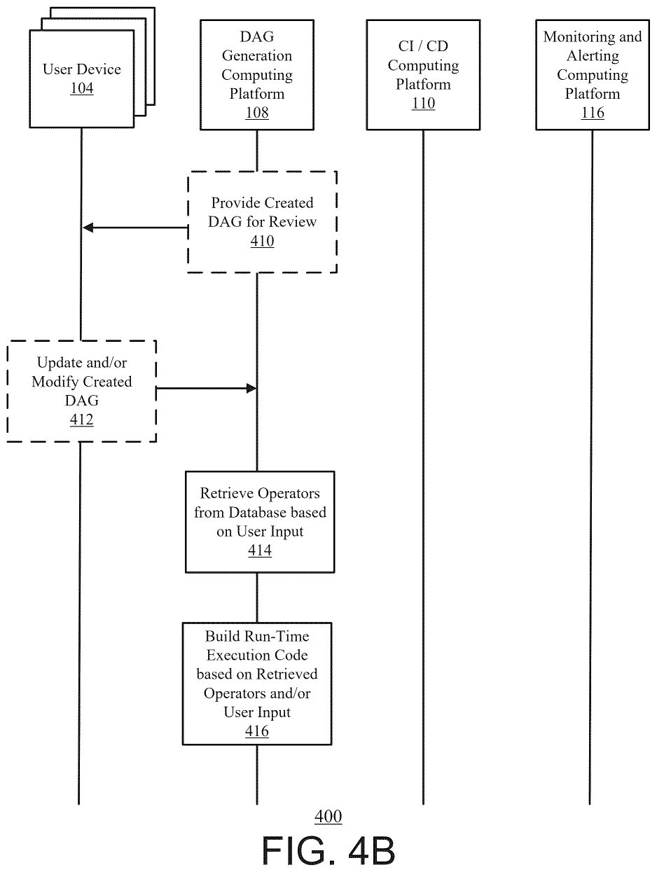

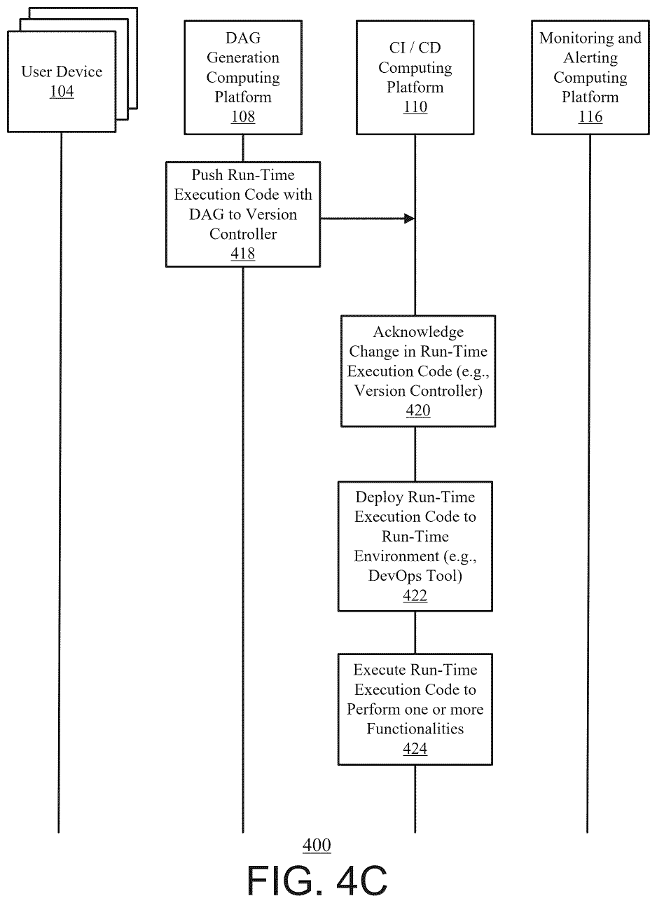

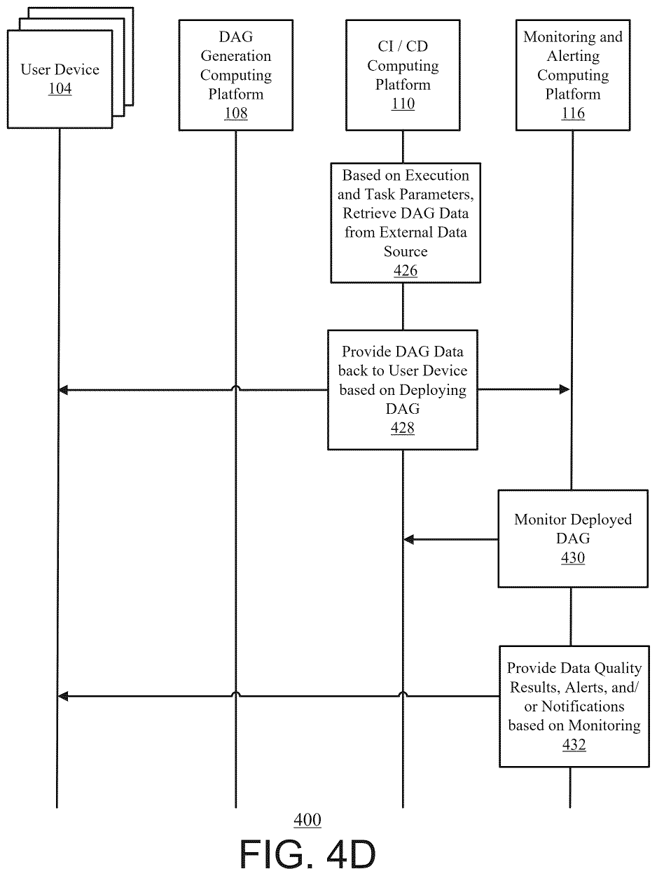

At block 302, the DAG generation computing platform 108 may create a DAG based on instructions from a user device 104. The DAG may indicate a plurality of tasks and a plurality of indicators indicating a sequential flow for performing the plurality of tasks. This will be described in blocks 402-408 of FIG. 4A below.

At block 304, based on the created DAG, the DAG generation computing platform 108 may retrieve a plurality of operators for the plurality of tasks from one or more databases. This will be described in block 414 of FIG. 4B below.

At block 306, the DAG generation computing platform 108 may build run-time execution code for the created DAG based on the plurality of retrieved operators and the sequential flow for performing the plurality of tasks. This will be described in block 416 of FIG. 4B below.

At block 308, the DAG generation computing platform 108 may push the run-time execution code to a CI/CD computing platform 110. The CI/CD computing platform 110 may be configured to deploy and execute the run-time execution code for the created DAG. This will be described in blocks 418-428 of FIGS. 4C and 4D below.

FIGS. 4A-4D show an exemplary event sequence for the automated generation, deployment, and execution of DAGs in accordance with one or more examples of the present application. However, the event sequence 400 is merely an example and other types of event sequences are contemplated herein including by performing any of the following blocks in any suitable order. The event sequence 400 includes operations, processes, and/or functions that are performed by one or more entities within the environment 100. For example, the event sequence 400 includes blocks performed by the user devices 104, the DAG generation computing platform 108, the CI/CD computing platform 110, and the monitoring and alerting computing platform 116. In some examples, FIGS. 4A-4D may show an industry-leading event sequence implementation, which may showcase a best-in-class approach to automated DAG management and may reduce processing time by over 60%.

For example, currently, the majority of workflows are operated on a cloud computing platform. However, due to operating on a cloud computing platform where numerous users 102 and user devices 104 may be collaborating together to achieve goals for the enterprise organization, different requirements have to be satisfied. To achieve these goals, a workflow tool such as the APACHE AIRFLOW may be used to perform one or more functionalities. For instance, as a simple example, a user 102 may be working in a manufacturing plant and seek to present data on run-time operations of the manufacturing plant over the previous day to their co-workers. The user 102 may need to download data from a plurality of different machinery across different machinery lines, aggregate the data together, and then present the data to their co-workers. Instead of manually downloading the data from the different machinery lines, which may be located in different geographic areas, a workflow may be configured to perform each of these tasks. For example, using the user device 104, the user 102 may create a DAG, which may be a workflow in APACHE AIRFLOW, that automates the desired functionality above. For instance, the DAG may indicate the tasks necessary to perform the desired functionality as well as the ordering and sequence for the tasks. As such, in the example above, the DAG may indicate to download data associated with the run-time operations of the manufacturing plant. Then, the downloaded data may be stored in a repository. Following, an email that includes the downloaded data may be provided to the user device 104 associated with the user 102 each morning.

As an addition to the created DAG above, the user 102 may further seek to perform data quality checks such that the downloaded data is accurate. To perform these data quality checks, a task needs to be created within the DAG, but it also needs to be sequenced properly. For instance, if the data quality check is performed prior to downloading the data, then the data quality check will not be accurate given that no data has been downloaded. In addition, the data may become available within the external data sources at different times of the day. For example, manufacturing lines may operate for a few hours and may upload their data into the external data sources after operation. Thus, the manufacturing lines may upload their data at different times, and it may be necessary to perform the data quality checks at these different time instances. Thus, the created DAG may be required to handle these and other issues that may arise to ensure that the workflow is properly managed.

To put it another way, a DAG may be a collection of tasks that are desired to be executed, and the tasks may be organized in a way that reflects their relationships and dependencies (e.g., the DAG may indicate a sequential flow for performing the tasks). In addition, the DAG may be defined within a software code such as PYTHON script, which may represent the DAG structure (e.g., the tasks and dependencies as code). However, the manual creation of DAGs may lead to technical problems including, but not limited to, being error prone, lack of enforcement of standards, time consuming, frustrating deployment aspects, different operators (e.g., software code associated with the tasks) requiring different DAG coding, lack of standard production practice, and/or frequent changes during upgrades.

For example, when the underlying environment (e.g., the orchestration and execution computing platform 114) supporting these DAGs/Pipelines is upgraded (e.g., changes to AIRFLOW or COMPOSER version or shifts in the supported PYTHON version), significant challenges may arise in manually created DAGs. These upgrades often introduce breaking changes in libraries, dependencies, and/or operator (task) syntax used within DAGs. Consequently, each manually created DAG must be individually inspected and modified to ensure compatibility with the new environment. In contrast, based on using the process 300 and/or the event sequence 400, the above issues are avoided as generated DAGs may be automatically compliant with the upgraded environment.

Additionally, and/or alternatively, based on using process 300 and/or the event sequence 400, this may allow for implementation of user-friendly interfaces for DAG management, provide intuitive configuration options through web-base user interfaces (UIs), offer automated validation and/or syntax checking, include comprehensive documentation and tooltips, enable template-based DAG creation for common patterns, incorporate drag-and-drop functionality for task arrangement, feature built-in testing and debugging tools, support version control integration, and/or provide real-time feedback on configuration changes. Additionally, and/or alternatively, the process 300 and/or the event sequence 400 may include additional technical benefits. For instance, conventional approaches may have system-wide vulnerabilities such as poorly written orchestration code that may trigger cascading failures across the entire server infrastructure. Further, a single misconfigured DAG may potentially bring down the entire orchestration platform (e.g., the orchestration and execution computing platform 114). In addition, system failures may paralyze multiple teams and organizations simultaneously, which may result in significant business disruption. Additionally, conventional approaches may have resource management risks such as unoptimized code that may lead to memory leaks and resource exhaustion, infinite loops or deadlocks that may consume all available computing resources, and/or improper error handling that may cause resource lock-ups that require manual intervention. Further, conventional approaches may have maintenance challenges and/or operational impact such as developers must meticulously review and update hundreds or thousands of DAGs, manual updates are inherently error-prone and time-consuming, inconsistent coding styles between developers may create maintenance nightmares, heterogeneous codebases may become increasingly difficult to maintain and debug, failed DAG updates may render entire pipelines non-functional, unintended results may propagate through dependent systems, data integrity issues may arise from improperly modified workflows, and/or business-critical processes may experience unexpected downtime. In addition, conventional approaches may require mitigation requirements such as implementing robust version control and code review processes, establishing comprehensive testing protocols before deployment, creating automated validation checks for code quality, maintaining detailed documentation and audit trails, and/or deploying changes gradually with rollback capabilities. As such, based on utilizing process 300 and/or the event sequence 400, the above issues (e.g., system-wide vulnerabilities, resource management risks, maintenance challenges, and/or mitigation requirements) may be solved, reduced, mitigated, and/or eliminated.

To facilitate the above, the event sequence 400 may be used to automate the generation, deployment, and execution of DAGs and/or run-time execution code associated with the DAGs to perform one or more desired functionalities. By utilizing event sequence 400, numerous technical advantages may be achieved including, but not limited to, a user-friendly interface for building, deploying, and monitoring DAGs, standard production practice to facilitate easy support for migrations, and supporting custom-built operators for facilitating custom-built tasks for users 102. For example, the event sequence 400 might not only simplify the process of managing DAGs, but may also promote best practices in data quality and operational efficiency, ultimately empowering users 102 to achieve higher levels of productivity and confidence in their data workflows. Furthermore, by eliminating the need for coding and providing comprehensive support and monitoring tools, the event sequence 400 may transform the way enterprise organizations approach data pipeline management, making it accessible to a broader range of users 102 and significantly improving overall operational effectiveness.

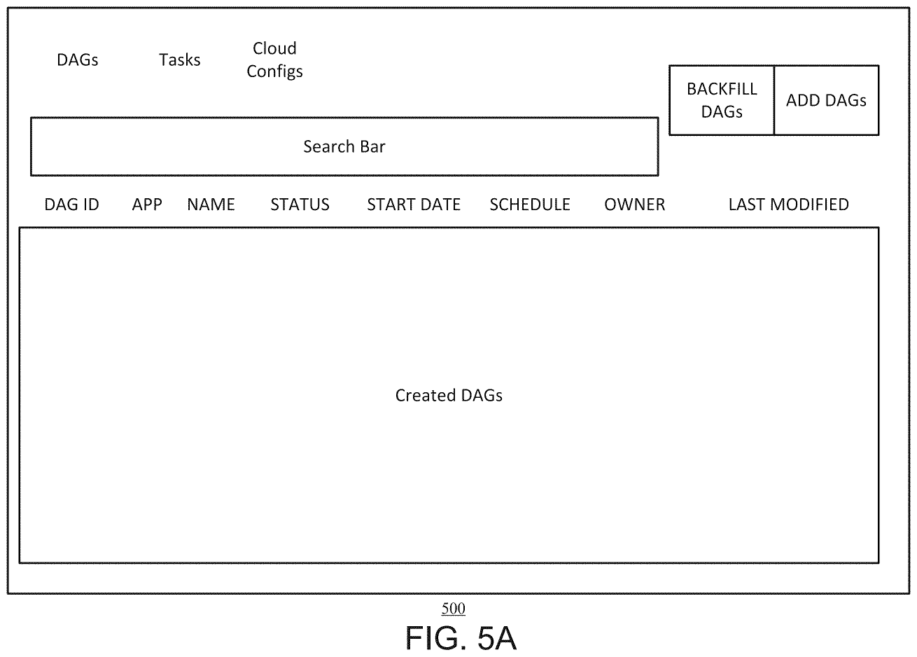

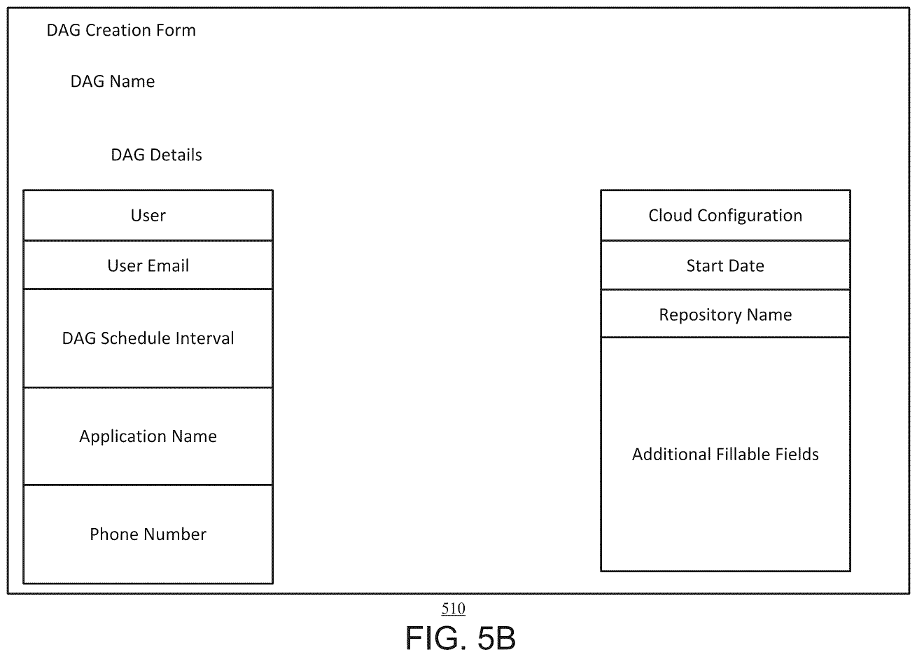

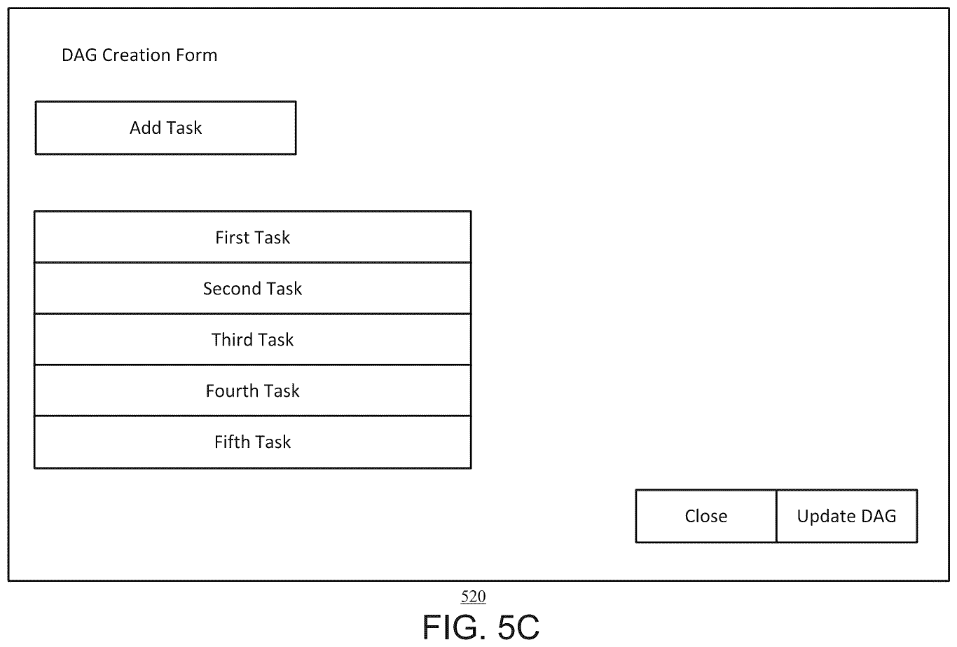

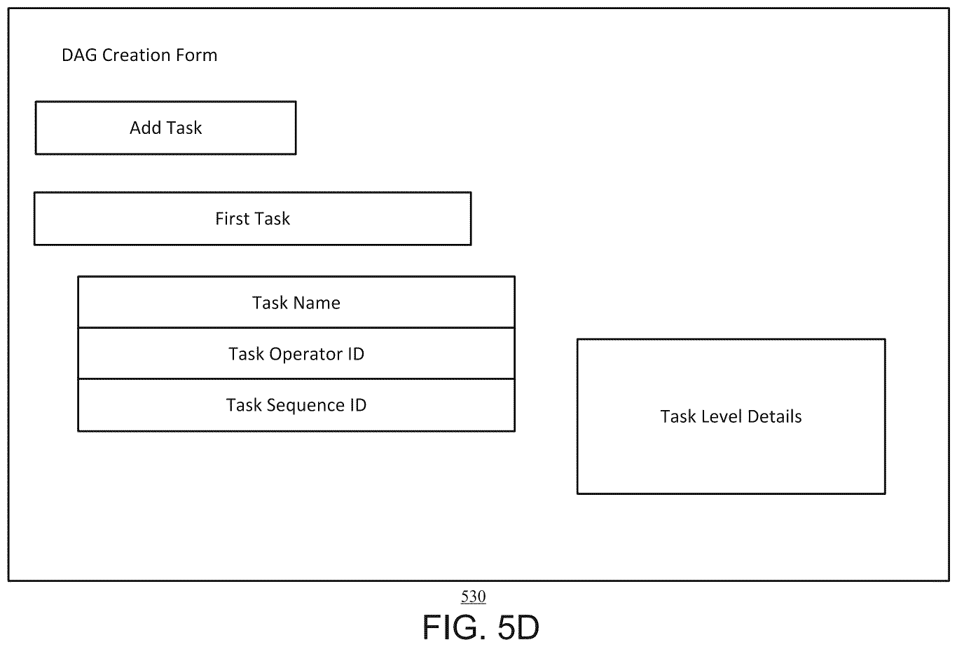

At block 402, a user device 104 from the user devices 104 accesses a DART portal to implement a new DAG. For example, the DART portal may be a user-interface hosted, managed, and/or otherwise associated with the DAG generation computing platform 108. Based on accessing the DART portal, the user device 104 may display user interfaces on a display device, and the user interfaces may include user input fields for creating, deploying, and/or implementing the DAG. For instance, the user interfaces may include general DAG information as well as specific DAG tasks and task parameters associated with the DAG tasks. Exemplary user interfaces are shown in FIGS. 5A-5D.

For example, FIGS. 5A-5D show exemplary user interfaces 500-530 that are used to create and/or update a DAG in accordance with one or more examples of the present application. For instance, FIGS. 5A-5D show a user interface design, which may empower users with intuitive DAG creation and modification capabilities that may increase team productivity by 75%. For example, at block 402, the user device 104 may access a DART portal such as the portal shown in the user interface 500 in FIG. 5A. Here, the user interface 500 shows a header indicating the DAGs, Tasks, and Cloud Configurations (Configs). The user interface 500 also shows user selection options such as options to backfill DAGs, Add DAGs, and a search bar to search for previously created DAGs. In addition, the Created DAGs as well as information associated with the created DAGs (e.g., the DAG identifier (ID) field, the Application (App) field, the name field, the status field, the start date field, the schedule field, the owner field, and the last modified field). The user 102, using the user device 104, may perform one or more selections such as to create a new DAG and/or modify a previously created DAG. Initially, the creation of a new DAG will be described and the modification of a previously created DAG will be described afterwards.

By selecting the Add DAG user selection, the event sequence 400 moves to block 404. At block 404, the user device 104 creates a new DAG template based on user input indicating new tasks and task parameters. For example, to create a DAG, the user 102 may use the DART portal to provide information for the DAG such as general information for the DAG, the new tasks for the DAG, and task parameters associated with the new tasks. Exemplary fillable fields for the user 102 to provide the information are shown in FIGS. 5B-5D. For example, FIG. 5B shows the user interface 510 after the user 102 selects the Add DAG selection in user interface 500. The user interface 510 includes fillable fields for the general information for the DAG such as the identity of the user, the user email, the DAG schedule interval (e.g., when the DAG should be executed), the Application name, phone number, cloud configuration, start date (e.g., when should the DAG begin execution), the repository name (e.g., the repository that the DAG should be stored within), and additional fillable fields. In some instances, the DAG schedule interval may indicate how often the DAG is executed (e.g., once a day, twice a day, and so on). In some instances, the repository name may indicate a GITHUB repository that indicates a storage location for the DAG and/or data associated with the DAG.

After filling out the general information, the user interface 520 from FIG. 5C may be displayed. Using the user interface 520, the tasks for the DAG may be created. For example, the user interface 520 shows five tasks to be created as well as a user selection for closing the user interface 520 and updating the DAG. After creating the tasks, the user interface 530 from FIG. 5D may be displayed. For instance, each of the five tasks shown in the user interface 520 may include a drop-down selection. When selecting the drop-down selection, the user interface 530 may be displayed that provides additional details for the task. In other words, the task parameter fields may be displayed such as the task name, task operator ID, task sequence ID (e.g., where in the DAG sequence the task should be performed), and task level details.

Using the exemplary user interfaces 500-530, the user device 104 may obtain user input indicating information for the creation of the DAG such as user input indicating general information, the tasks for the DAG, and the task parameters for the tasks.

At block 406, the user device 104 may provide instructions to generate and implement the DAG to the DAG generation computing platform 108. For example, based on the user input from block 404, the user device 104 may generate instructions indicating for the DAG to be created as well as information to used in the creation of the DAG. For instance, in the example above, the instructions may indicate to create a DAG to provide the user 102 with data associated with the manufacturing lines and/or machinery including a data quality check.

At block 408, the DAG generation computing platform 108 may create the DAG based on the instructions. For example, as mentioned above, the DAG may be a workflow that shows a sequence for executing each of the tasks indicated by the user device 104. For instance, a first task may be performed first, then a second task may be performed, and so on. Additionally, and/or alternatively, one or more tasks may be performed in parallel rather than sequentially. For instance, multiple different data files may be downloaded from different external data sources. As such, the DAG may include individual tasks that are performed in parallel to download the data files from the different external data sources.

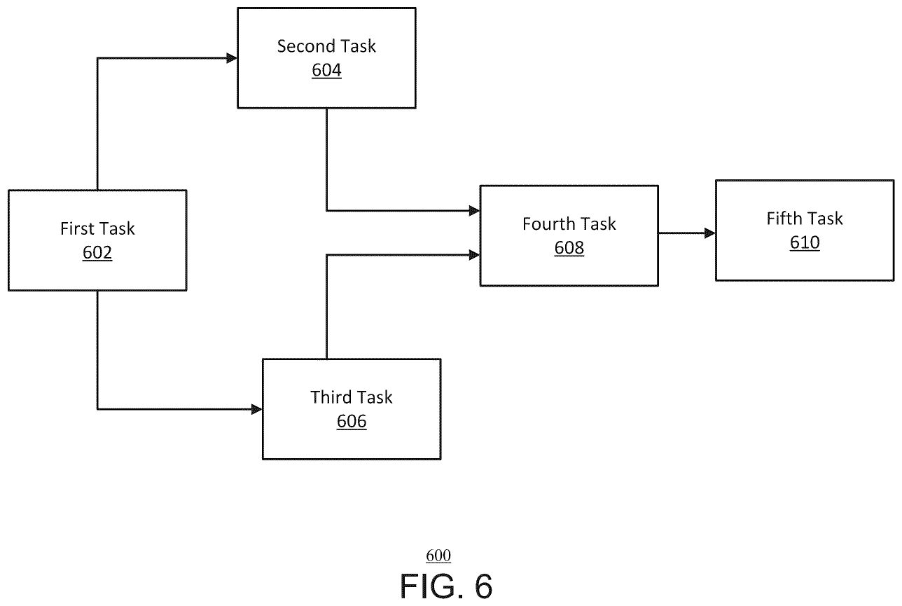

FIG. 6 shows an exemplary DAG 600 that may be created by the DAG generation computing platform 108. For example, FIG. 6 shows a cutting-edge DAG configuration framework, which has successfully processed over one million transactions while maintaining 99.9% uptime. For instance, the DAG 600 includes five tasks 602-610 and shows the sequential flow for the five tasks 602-610. For instance, the first task 602 is to be performed first and then the second and third tasks 604 and 606 are to be performed in parallel. Following, the fourth task 608 is to be performed. Finally, the fifth task 610 is to be performed. In some instances, the first task 602 may be to initiate the process, the second and third tasks 604 and 606 may be to download and store data in a repository, the fourth task 608 may be a data quality check, and the fifth task 610 may be to provide the downloaded data back to the user device 104.

Returning back to FIG. 4A, in some variations, one or more of the tasks (e.g., one or more of the tasks 602-610) may be associated with different operating codes, databases, and/or syntax. For instance, an initial task may be required to operate using a PYTHON file and another task in a Structured Query Language (SQL) file. Thus, given the complexity with utilizing the different operating codes, databases, and/or syntax, it may be difficult to manually create the execution code to execute the DAG after creation. As such, in the following, the event sequence 400 may describe blocks to build the execution code based on the DAG as well as to deploy and implement the execution code.

Referring to FIG. 4B and prior to describing the building and deployment of the execution code, optional blocks 410 and 412 are described. For example, prior to implementing the DAG, block 410 may be performed. When performed, the DAG generation computing platform 108 may provide the created DAG for review by the user device 104. For instance, if the DAG is inaccurate or if the user 102 provided incorrect information, the user device 104 may be allowed to fix the DAG prior to building the run-time execution code. At block 412, the user device 104 may update and/or modify the created DAG such as by providing user input and/or additional information.

Additionally, and/or alternatively, instead of creating a new DAG from the beginning to end, the same user 102 or a separate user 102 may decide to modify a pre-existing DAG. In such examples, the event sequence 400 may begin at block 410. For example, the user device 104 may provide a selection indicating a previous DAG that was created (e.g., based on using the user interface 500 from FIG. 5A). Subsequently, the user device 104 may provide user input indicating to modify one or more aspects of the previously created DAG such as aspects associated with the general information about the DAG, one or more tasks for the DAG (e.g., the creation and/or removal of one or more tasks), and/or task parameters for the one or more tasks. Subsequently, the updates may be provided to the DAG generation computing platform 108, and the DAG generation computing platform 108 may update the DAG.

Regardless whether a new DAG is being created or a previous DAG is being modified, at block 414, the DAG generation computing platform 108 retrieves operators from a database based on the user input. The operators may include software code, which may or might not be utilizing the same programming language (e.g., one operator may be associated with a SQL language and another operator may be associated with PYTHON). Further, each task may be associated with a particular operator. For example, a downloading data task from one or more external data sources may be associated with a particular operator and an emailing task may be associated with another operator. The operators may be stored in a database, repository, and/or other storage medium associated with the DAG generation computing platform 108. For example, the DAG generation computing platform 108 may include a database that stores the operators. The operators may be a standard template with configurable aspects that may be filled-in based on the task parameters from the user input. In some examples, the DAG generation computing platform 108 may retrieve a first operator from a first database based on a first programming language (e.g., SQL) and retrieve a second operator from a second database based on a second programming language (e.g., PYTHON).

In some examples, the DAG generation computing platform 108 may obtain from the user devices 104 and/or other sources, custom operators. For example, in addition to the standard operators, the DAG generation computing platform 108 may also store custom operators within the database that may be used to create DAGs. The standard and custom operators are described in further detail below.

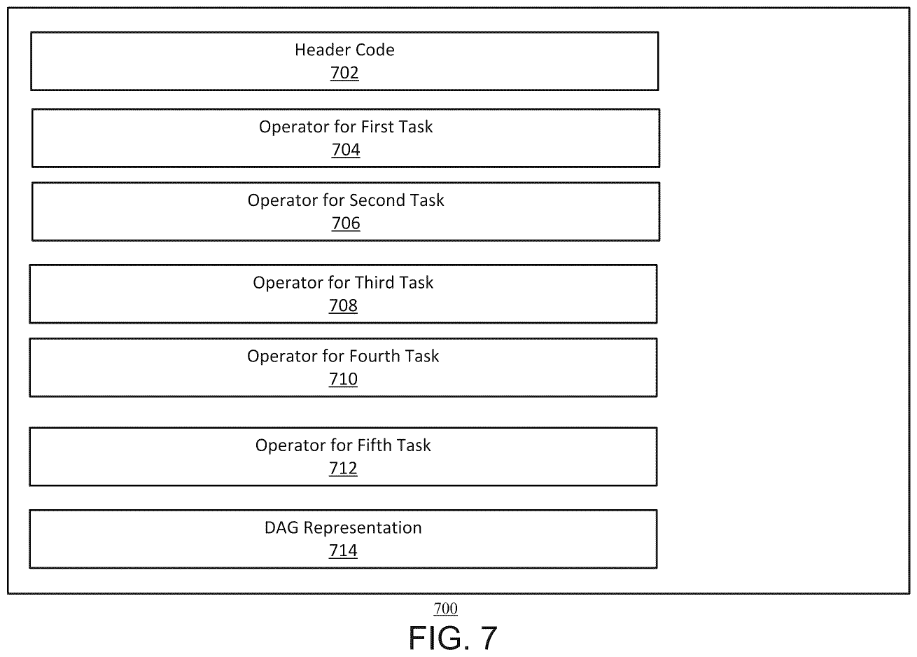

After retrieving the operators from the database, at block 416, the DAG generation computing platform 108 may build run-time execution code based on the retrieved operators and/or the user input. For example, the run-time execution code may indicate each of the tasks, the task parameters, and the general information. An exemplary run-time execution code is shown in FIG. 7. FIG. 7 shows exemplary run-time execution code 700 for the DAG in accordance with one or more examples of the present application. For example, FIG. 7 shows a run-time execution architecture, featuring intelligent optimization that has reduced resource consumption by 40% while improving performance. For instance, the run-time execution code 700 includes a header code 702, operators (e.g., software code) for the first through fifth tasks 704-714, and a DAG representation 714 in coded form.

For example, based on the user input indicating the task parameters and the retrieved operators from block 414, the DAG generation computing platform 108 may generate the operators for the first through fifth tasks 704-712. For instance, referring to FIG. 5D, for the first task, the user device 104 may provide task level details and the Operator ID. Based on the task level details as well as the Operator ID, the DAG generation computing platform 108 may generate the operator for the first task 704. In addition, the DAG generation computing platform 108 may generate the header code 702 based on the general information for the DAG. Furthermore, the DAG generation computing platform 108 may generate the DAG representation 714 based on the created DAG. For instance, the DAG representation 714 may be a representation of the DAG in coded form. In some instances, the DAG representation 714 for the DAG 600 shown in FIG. 6 may be “task1>>[task2, task3]>>task4>>task 5”. As such, the sequential order of the task may be shown by “>>” and the tasks to be performed in parallel may be shown by “[task2, task3].”

Referring to FIG. 4C, the DAG generation computing platform 108 may push the run-time execution code with the DAG to a version controller of the CI/CD computing platform 110. For example, the CI/CD computing platform 110 may be configured to ensure that the software applications, DAGs, and/or other programs may be stable and executable. For instance, given the cloud computing environment, multiple different operators and/or users may seek to create DAGs and/or programs, including creating and/or modifying their own DAGs. The CID/CD computing platform 110 may include a version controller that checks the run-time codes to ensure compliance. For example, a DAG may already be operating on the CI/CD computing platform 110 and the user 102 may seek to modify and/or update the DAG. The version controller of the CI/CD computing platform 110 may be used to check and/or acknowledge the compliance of the run-time execution code prior to deploying and executing the run-time execution code. This is described in block 420.

For example, at block 420, the CI/CD computing platform 110 acknowledges the change in run-time execution code. For instance, the CI/CD computing platform 110 may check whether there is a previous version of the run-time execution code associated with the DAG. If there is a previous version, then the CI/CD computing platform 110 may review and acknowledge the change in the run-time execution code (e.g., use the version controller to compare the updated run-time execution code with the run-time execution code currently being executed by the CI/CD computing platform 110 and acknowledge the changes within the updated run-time execution code based on the comparison). If there is not a previous version (e.g., the user 102 has created a new DAG to be deployed), the CI/CD computing platform 110 may acknowledge the new DAG (e.g., that the new DAG has not been previously deployed by the CI/CD computing platform 110). In other words, the CI/CD computing platform 110 may ensure that the run-time execution code is ready for production, and other users 102 may review the run-time execution code (e.g., for collaboration purposes).

At block 422, the CI/CD computing platform 110 may deploy the run-time execution code to a run-time environment. For example, the CI/CD computing platform 110 may include a DevOps tool that deploys the run-time execution code into the run-time environment. For instance, the CI/CD computing platform 110 may take the new/updated run-time execution code and deploy the code within the cloud computing platform, within a container, and/or within other aspects.

At block 424, after deployment, the CI/CD computing platform 110 may execute the run-time execution code to perform one or more functionalities. Referring to FIG. 4D, at block 426, based on the execution and task parameters, the CI/CD computing platform 110 may retrieve the DAG data from external data sources. For instance, based on deploying the run-time execution code, the CI/CD computing platform 110 may execute the run-time execution code to perform one or more functionalities. In the example above, the user 102 may seek to obtain manufacturing data each day. As such, the CI/CD computing platform 110 may generate the DAG as well as the run-time execution code, and execute the run-time execution code to download the desired data. As such, the CI/CD computing platform 110 may retrieve the DAG data from the external data sources (e.g., the manufacturing data from the external data sources that store this data). The DAG data may be and/or include any data that may be desired by the user 102 and/or the user device 104 to perform their responsibilities for the enterprise organization.

At block 428, the CI/CD computing platform 110 may provide the DAG data to the user device 104 and the monitoring and alerting computing platform 116. For instance, the CI/CD computing platform 110 may provide the requested data back to the user device 104. In other words, instead of merely just generating a DAG, the event sequence 400 describes the actual implementation of the DAG including a block for providing the requested DAG data back to the user device 104. As mentioned previously, this requested DAG data may be provided back to the user device 104 at requested time intervals such as every morning.

Furthermore, the event sequence 400 may perform monitoring for the DAG. For instance, based on the above and given the standardization, the monitoring and alerting computing platform 116 may be configured to monitor the deployed DAGs and/or the deployed run-time execution code to ensure that the DAG is functioning properly. For example, given the sequential nature of DAGs, if one task fails, then this may lead to cascading failures for the tasks following the failed task. As such, the monitoring and alerting computing platform 116 may be configured to determine not only that the DAG failed, but the purpose or how the task failed. Thus, the monitoring and alerting computing platform 116 may obtain the provided DAG data as well.

Then, at block 430, the monitoring and alerting computing platform 116 may monitor the deployed DAG. At block 432, the monitoring and alerting computing platform 116 may provide data quality results, alerts, and/or notifications based on the monitoring. For instance, if the DAG data is empty, the monitoring and alerting computing platform 116 may review the DAG to identify a failure point, and then provide information back to the user device 104 indicating the failure point (e.g., the DAG data was not downloaded properly from the external data sources).

For instance, as an example, the data quality check for the DAG fails, which prevents a follow-up task (e.g., a PYTHON script) from running. Thus, the monitoring and alerting computing platform 116 may obtain a notification indicating the failure and determine the failure details. The monitoring and alerting computing platform 116 may further attempt to find a resolution (e.g., review, modify, and/or fix the operators stored in the database of the DAG generation computing platform 108). If the monitoring and alerting computing platform 116 is unable to find the resolution, the monitoring and alerting computing platform 116 may provide a notification back to the user device 104 indicating the failure. The user 102 may then seek to modify the DAG to fix the failure themselves.

In some variations, the monitoring processes (e.g., blocks 430 and 432) may be initiated concurrently with the primary DAG execution tasks (e.g., blocks 426 and 428). In other words, the monitoring and alerting computing platform 116 may perform the monitoring processes in parallel with the CI/CD computing platform 110 performing the primary DAG execution tasks. For example, as soon as a DAG execution begins, the monitoring and alerting computing platform 116 may immediately start monitoring the DAG for both execution failures and/or data quality issues. For example, if user device 104 is expecting a report generated by the DAG, and that report is empty and/or fails pre-defined data quality checks, the DAG execution may terminate. Furthermore, the monitoring and alerting computing platform 116 may promptly notify the user 102, indicating the specific data quality check that failed (e.g., ‘report is empty’). This immediate feedback may allow the user 102 to rapidly investigate the root cause, which may stem from external factors, such as a manufacturing device failing to capture data. After resolving the underlying issue, the user 102 may then re-run the DAG. Therefore, the monitoring and alerting computing platform 116 may provide continuous state monitoring of the DAG throughout its execution and based on pre-configured data quality tasks, assess the quality of data within reports, tables, and/or spreadsheets. In other words, in response to and/or subsequent to the DAG generation computing platform 108 pushing the run-time execution code to the CI/CD computing platform 110, the monitoring and alerting computing platform 116 may monitor the deployment and execution processes performed by the CI/CD computing platform 110. Based on the monitoring, the monitoring and alerting computing platform 116 may provide data quality results and/or notifications to the user device 104.

In some examples, based on utilizing the event sequence 400, numerous benefits may be achieved. For instance, the above may allow users 102 to build, deploy, and monitor DAGs without any coding, making it accessible to a wider audience, including those without technical expertise. Additionally, and/or alternatively, the above may significantly enhance productivity, allowing teams to focus on more strategic initiatives rather than manual processes. Additionally, and/or alternatively, the above may further allow for standardization by utilizing pre-built templates and/or standard production practices to ensure consistency across deployments, which may reduce errors and improve overall quality in data management. Additionally, and/or alternatively, the above may provide enhanced data quality to ensure that data integrity is maintained and operational risks are minimized. Additionally, and/or alternatively, the above may allow for proactive monitoring and issue resolution, which may allow for users 102 to proactively identify and resolve issues before they escalate, which may lead to improved system reliability and performance. Additionally, and/or alternatively, the above may allow for modular design, which permits easy future enhancements and updates that ensure for evolution of the event sequence 400 alongside changing needs and technological advancements. Additionally, and/or alternatively, the above may allow for supporting multiple operators and continuously developing new ones, which provides flexibility and adaptability to various use cases and accommodates diverse operational requirements. Additionally, and/or alternatively, the above may allow for improved data trustworthiness by integrating a robust monitoring and reporting framework, which enhances trustworthiness of data that is crucial for informed decision-making and compliance. Additionally, and/or alternatively, the above may simply the DAG management process, which empowers users 102 at all levels to take control of their data workflows. Additionally, and/or alternatively, the above may allow for a significant advancement by combining ease of use, efficiency, and robust data quality management, which may ultimately transform how enterprise organizations handle their data pipelines.

In some examples, the operators stored in the database associated with the DAG generation computing platform 108 may include a bash operator. The bash operator may allow users 102 to run arbitrary commands or scripts within a bash shell. Additionally, and/or alternatively, the database may include a PYTHON operator, which allows users to execute a PYTHON callable when a task is called. Additionally, and/or alternatively, the database may include a big query insert job operator, which helps in managing data to analyze and find/extract meaningful insights. Additionally, and/or alternatively, the database may include a data processing (Dataproc) submit job operator, which allows submitting jobs of different big data components.

Additionally, and/or alternatively, the database may include a Dataproc create cluster operator and/or a Dataproc delete cluster operator. Additionally, and/or alternatively, the database may include a GOOGLE CLOUD STORAGE (GCS) to BigQuery Operator, which may be used to populate BigQuery tables with data from files stored in a cloud storage bucket. Additionally, and/or alternatively, the database may include an email operator that includes the configuration for sending an email to the user devices 104. Additionally, and/or alternatively, the database may include a trigger DAG run operator, which includes the configuration for triggering a specific DAG. Additionally, and/or alternatively, the database may include an external task sensor, which makes tasks on a DAG wait for another task on a different Dag for a specific execution date.

Additionally, and/or alternatively, the database may include a Beam Run JAVA pipeline operator, which launches APACHE Beam pipelines written in JAVA. Additionally, and/or alternatively, the database may include a Beam Run PYTHON pipeline operator, which launches APACHE Beam pipelines written in Python. Additionally, and/or alternatively, the database may include a Big Table Create Table Operator, which creates a cloud Bigtable instance. Additionally, and/or alternatively, the database may include a Big Table Delete Table Operator, which deletes a table in the cloud Bigtable. Additionally, and/or alternatively, the database may include an object existence sensor operator, which checks for the existence of a file in a cloud storage. Additionally, and/or alternatively, the database may include a delete object operator, which deletes objects from cloud storage, either from an explicit list of object names or all objects matching a prefix. Additionally, and/or alternatively, the database may include a Secure Shell File Transfer Protocol (SFTP) egress operator, which may be used to send files and/or artifacts to a remote SFTP server. Additionally, and/or alternatively, the database may include an SFTP ingress operator, which transfers files from a remote host to local. Additionally, and/or alternatively, the database may include a custom external task sensor, which makes tasks on a DAG wait for another task on a different DAG for a specific execution date.

A number of implementations have been described. Nevertheless, it will be understood that additional modifications may be made without departing from the scope of the inventive concepts described herein, and, accordingly, other examples are within the scope of the following claims. For example, it will be appreciated that the examples of the application described herein are merely exemplary. Variations of these examples may become apparent to those of ordinary skill in the art upon reading the foregoing description. The inventor expects skilled artisans to employ such variations as appropriate, and the inventor intends for the application to be practiced otherwise than as specifically described herein. Accordingly, this application includes all modifications and equivalents of the subject matter recited in the claims appended hereto as permitted by applicable law. Moreover, any combination of the above-described elements in all possible variations thereof is encompassed by the application unless otherwise indicated herein or otherwise clearly contradicted by context.

It will further be appreciated by those of skill in the art that the execution of the various machine-implemented processes and steps described herein may occur via the computerized execution of processor-executable instructions stored on a non-transitory computer-readable medium, e.g., random access memory (RAM), read-only memory (ROM), programmable read-only memory (PROM), volatile, nonvolatile, or other electronic memory mechanism. Thus, for example, the operations described herein as being performed by computing devices and/or components thereof may be carried out by according to processor-executable instructions and/or installed applications corresponding to software, firmware, and/or computer hardware.

The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the application and does not pose a limitation on the scope of the application unless otherwise claimed. No language in the specification should be construed as indicating any non-claimed element as essential to the practice of the application.

1. A computing system, comprising:
a user device configured to:
obtain user input comprising new tasks and new task parameters for creation of a new Directed Acyclic Graph (DAG), wherein the user input indicates for the new DAG to download DAG data from one or more external data sources and provide the DAG data back to the user device at a set time interval; and
based on the user input, provide instructions to a DAG generation computing platform to direct the DAG generation computing platform to generate and implement the new DAG;
the DAG generation computing platform configured to:
create the new DAG based on the instructions, wherein the new DAG indicates the new tasks and a plurality of indicators indicating a sequential flow for performing the new tasks;
based on the created DAG, retrieve a plurality of operators for the new tasks from one or more databases;
build run-time execution code for the created DAG based on the plurality of retrieved operators and the user input; and
push the run-time execution code to a continuous integration and continuous deployment (CI/CD) computing platform; and
the CI/CD computing platform configured to:
deploy the run-time execution code within a run-time environment; and
execute the deployed run-time execution code to perform the new tasks, wherein executing the deployed run-time execution code comprises:
downloading the DAG data from the one or more external data sources; and
providing the DAG data back to the user device at the set time interval.

2. The computing system of claim 1, wherein obtaining the user input comprises:
accessing a DAG automation and reporting tool (DART) portal hosted by the DAG generation computing platform;
based on accessing the DART portal, displaying one or more user interfaces on a display of the user device; and
obtaining the user input based on the one or more displayed user interfaces.

3. The computing system of claim 2, wherein obtaining the user input based on the one or more displayed user interfaces comprises:
based on displaying a first user interface of the one or more user interfaces, obtain first user input indicating general information associated with the new DAG;
based on displaying a second user interface of the one or more user interfaces, obtain second user input indicating the new tasks for the new DAG, wherein the new tasks comprise a first task; and
based on displaying a third user interface of the one or more user interfaces, obtain third user input indicating the new task parameters for the first task for the new DAG.

4. The computing system of claim 1, wherein the new tasks comprise a first task associated with a first programming language and a second task associated with a second programming language that is different from the first programming language, and wherein retrieving the plurality of operators for the new tasks comprises:
retrieving a first operator from a first database from the one or more databases based on the first programming language associated with the first task; and
retrieving a second operator from a second database from the one or more databases based on the second programming language associated with the second task.

5. The computing system of claim 4, wherein the DAG generation computing platform is further configured to:
obtain the first operator from a second user device, wherein the first operator is a custom operator; and
store the first operator within the first database, wherein the first database stores a plurality of custom operators.

6. The computing system of claim 1, wherein the CI/CD computing platform is further configured to:
obtain the run-time execution code from the DAG generation computing platform; and
acknowledge that the run-time execution code associated with the new DAG has not been previously deployed by the CI/CD computing platform, wherein deploying the run-time execution code within the run-time environment is based on the acknowledgement.

7. The computing system of claim 6, wherein the CI/CD computing platform comprises a version controller and a development operations (DevOps) tool, wherein the CI/CD computing platform is configured to acknowledge that the run-time execution code is associated with the new DAG using the version controller, and wherein the CI/CD computing platform is configured to deploy the run-time execution code within the run-time environment using the DevOps tool.

8. The computing system of claim 1, further comprising:
a monitoring and alerting computing platform configured to:
subsequent to the CI/CD computing platform deploying the run-time execution code, monitor the deployed DAG; and
provide, to the user device, data quality results and/or notifications associated with the CI/CD computing platform executing the run-time execution code for the deployed DAG.

9. The computing system of claim 1, further comprising:
a monitoring and alerting computing platform configured to:
in response to the DAG generation computing platform pushing the run-time execution code to the CI/CD computing platform, monitor the deployment and execution of the run-time execution code by the CI/CD computing platform; and
provide, to the user device, data quality results and/or notifications associated with monitoring the CI/CD computing platform.

10. A method, comprising:
creating a Directed Acyclic Graph (DAG) based on instructions from a user device, wherein the DAG indicates a plurality of tasks and a plurality of indicators indicating a sequential flow for performing the plurality of tasks;
based on the created DAG, retrieving a plurality of operators for the plurality of tasks from one or more databases;
building run-time execution code for the created DAG based on the plurality of retrieved operators and the sequential flow for performing the plurality of tasks; and
pushing the run-time execution code to a continuous integration and continuous deployment (CI/CD) computing platform, wherein the CI/CD computing platform is configured to deploy and execute the run-time execution code for the created DAG.

11. The method of claim 10, wherein the plurality of tasks comprise a first task associated with a first programming language and a second task associated with a second programming language that is different from the first programming language, and wherein retrieving the plurality of operators for the plurality of tasks comprises:
retrieving a first operator from a first database from the one or more databases based on the first programming language associated with the first task; and
retrieving a second operator from a second database from the one or more databases based on the second programming language associated with the second task.

12. The method of claim 11, further comprising:
obtaining the first operator from a second user device, wherein the first operator is a custom operator; and
storing the first operator within the first database, wherein the first database stores a plurality of custom operators.

13. The method of claim 10, further comprising:
obtaining additional instructions from the user device indicating one or more updates to the created DAG; and
updating the run-time execution code for the created DAG based on the one or more updates.

14. The method of claim 13, further comprising:
providing the created DAG to the user device for review, wherein obtaining the additional instructions from the user device is in response to providing the created DAG to the user device for review, and wherein pushing the run-time execution code to the CI/CD computing platform comprises pushing the updated run-time execution code for the created DAG to the CI/CD computing platform.

15. The method of claim 13, wherein obtaining the additional instructions from the user device indicating the one or more updates to the created DAG is subsequent to the CI/CD computing platform deploying and executing the run-time execution code for the created DAG, and wherein the method further comprises:
pushing the updated run-time execution code to the CI/CD computing platform;
using, by the CI/CD computing platform, a version controller to compare the updated run-time execution code with the run-time execution code that is currently being executed;
acknowledging, by the CI/CD computing platform, changes within the updated run-time execution code based on the comparison; and
deploying, by the CI/CD computing platform, the updated run-time execution code based on the acknowledgement.

16. The method of claim 15, wherein the CI/CD computing platform comprises the version controller and a development operations (DevOps) tool, wherein deploying the updated run-time execution code comprises deploying, using the DevOps tool, the run-time execution code within the run-time environment.

17. The method of claim 10, further comprising:
obtaining, by the CI/CD computing platform, the run-time execution code from a DAG generation computing platform;
acknowledging, by the CI/CD computing platform, that the run-time execution code associated with the DAG has not been previously deployed by the CI/CD computing platform; and
deploying, by the CI/CD computing platform, the run-time execution code within a run-time environment based on the acknowledgement.

18. The method of claim 10, further comprising:
subsequent to the CI/CD computing platform deploying the run-time execution code, monitoring, by a monitoring and alerting computing platform, the DAG; and
providing, by the monitoring and alerting computing platform and to the user device, data quality results and/or notifications associated with the CI/CD computing platform executing the run-time execution code for the DAG.

19. The method of claim 10, further comprising:
in response to pushing the run-time execution code to the CI/CD computing platform, monitoring, by a monitoring and alerting computing platform, the deployment and execution of the run-time execution code by the CI/CD computing platform; and
providing, by the monitoring and alerting computing platform and to the user device, data quality results and/or notifications associated with monitoring the CI/CD computing platform.

20. A non-transitory computer-readable medium having processor-executable instructions stored thereon, wherein the processor-executable instructions, when executed, facilitate:
creating a Directed Acyclic Graph (DAG) based on instructions from a user device, wherein the DAG indicates a plurality of tasks and a plurality of indicators indicating a sequential flow for performing the plurality of tasks;
based on the created DAG, retrieving a plurality of operators for the plurality of tasks from one or more databases;
building run-time execution code for the created DAG based on the plurality of retrieved operators and the sequential flow for performing the plurality of tasks; and
pushing the run-time execution code to a continuous integration and continuous deployment (CI/CD) computing platform, wherein the CI/CD computing platform is configured to deploy and execute the run-time execution code for the created DAG.
